(19) United States
(12) Patent Application Publication
(10) Pub. No.: US 2018/0268340 A1
(43) Pub. Date: Sep. 20, 2018

(54) ORGANIZATION HEALTH MANAGEMENT METHOD AND SYSTEM THEREFOR

(71) Applicant: Wipro Limited, Bangalore (IN)

(72) Inventor: Baleshwar SRIVASTAVA, Sunnyvale, CA (US)

(73) Assignee: Wipro Limited

(21) Appl. No.: 15/459,274

(22) Filed: Mar. 15, 2017

(51) Int. Cl. G06Q 10/06

(52) U.S. Cl. CPC G06Q 10/06395

(57) ABSTRACT

Embodiments of the present disclosure relates to a method and a system for enabling health management. More particularly, the proposed method and system provides a 360-degree view of the organization to determine performance affecting factors of the organization with regard to competition, competitors, and suppliers and so on. The proposed method determines the performance affecting factors of an organization based on data from multiple sources to identify influencing factors at the organization level or at the individual business units within the organization. Further, the proposed method determines the performance of an organization against various external affecting factors to identify impacting health factors and derive necessary corrective measures or recommendations or feedback on these factors to improve the overall performance of the organization

### FIELD OF THE DISCLOSURE

The present subject matter is related, in general to enterprise management, and more particularly, but not exclusively to a method and system for improving performance of an organization.

### BACKGROUND

Enterprises and organizations work in different ecosystem environments facing more challenges in maintaining good financial investments, good client relationships, organizing efficient day to day operations, tough competition from competitors, adhering to policies laid down by the local governing bodies, tackling and aligning along with inflations, macroeconomic factors like GDP etc. which affect sustained growth and good financial health of an organization. Additionally, the large organizations are further split into multiple business units due to various factors and each business unit's performance can be impacted by various internal/external macroeconomic factors. In these conditions, it's very difficult to manage and fine tune individual units. Also, this can result in direct/accumulative loss of revenue for the entire organization and results in organization collapse over some time.

Current systems have organization monitoring or operations monitoring solutions that run for the individual organization and consider only organizational internal factors. However, these solutions do not consider external factors (like economic changes in GDP, inflation rates, competitors, customers, and suppliers) and correct issues effectively through automated methods, thereby resulting in isolation of the organization from its ecosystem and create problems either immediately or over an extended period regarding its health. Therefore, there is a need for a method and a system that identifies the impacting factors affecting the sustained organizational growth and improves the performance of the organization.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of identifying health impacting factor to improve performance of an organization. The method includes receiving a plurality of organization related data collected from one or more internal sources associated with the organization. The method further comprises identifying one or more internal factors affecting the health of the organization based on processing of the plurality of organization related data. The method also comprises receiving external data from a plurality of external sources and one or more user inputs related to customization requirements. Upon receiving, a plurality of health impacting factors of the organization is determined based on the analysis of the one or more internal factors and the external data thus received. Based on the health impacting factors, feedback and corrective recommendations are generated to improve the performance of the organization.

Further, the present disclosure relates to a health management system for an organization. The system includes at least a data repository configured to store a plurality of organization related data and external data received from a plurality of external sources. The system further comprises a processor coupled with the data repository. The system also includes a memory communicatively coupled with the processor, wherein the memory stores processor-executable instructions, which, on execution, cause the processor to receive the plurality of organization related data collected from one or more internal sources associated with the organization. Further, the processor is configured to identify one or more internal factors affecting the health of the organization based on processing of the plurality of organization related data. The processor is further configured to receive the external data and one or more user inputs related to customization requirements and determine a plurality of health impacting factors of the organization based on the analysis of the one or more internal factors and the external data received. Based on the health impacting factors, the processor generates feedback and corrective recommendations to improve the performance of the organization.

Furthermore, the present disclosure relates to a non-transitory computer readable medium including instructions stored thereon that when processed by at least one processor cause a health management system to receive a plurality of organization related data collected from one or more internal sources associated with the organization. The processor further identifies one or more internal factors affecting the health of the organization based on processing of the plurality of organization related data. Furthermore, the processor receives external data from a plurality of external sources and one or more user inputs related to customization requirements. Based on the analysis of the one or more internal factors and the external data received, the processor determines a plurality of health impacting factors of the organization and further generates feedback and corrective recommendations to improve the performance of the organization based on the plurality of health impacting factors thus determined.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed embodiments. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an architecture diagram of an exemplary system for enabling health management in accordance with some embodiments of the present disclosure;

FIG. 2 illustrates an exemplary block diagram of a health management system of FIG. 1 in accordance with some embodiments of the present disclosure;

FIG. 3a illustrates a flowchart of an exemplary method of enabling health management in accordance with some embodiments of the present disclosure;

FIG. 3b illustrates an exemplary correlation analysis and FIG. 3c illustrates an exemplary prediction line for an organization in accordance with some embodiments of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “include(s)”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relates to a method and a system for enabling health management. More particularly, the proposed method and system provides a 360-degree view of the organization to determine performance affecting factors of the organization regarding competition, competitors, and suppliers and so on. The proposed method determines the performance affecting factors of an organization based on data from multiple sources to identify influencing factors at the organization level or at the individual business units within the organization. Further, the proposed method determines the performance of an organization against various external affecting factors to identify impacting health factors and derive necessary corrective measures or recommendations or feedback on these factors to improve the overall performance of the organization.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

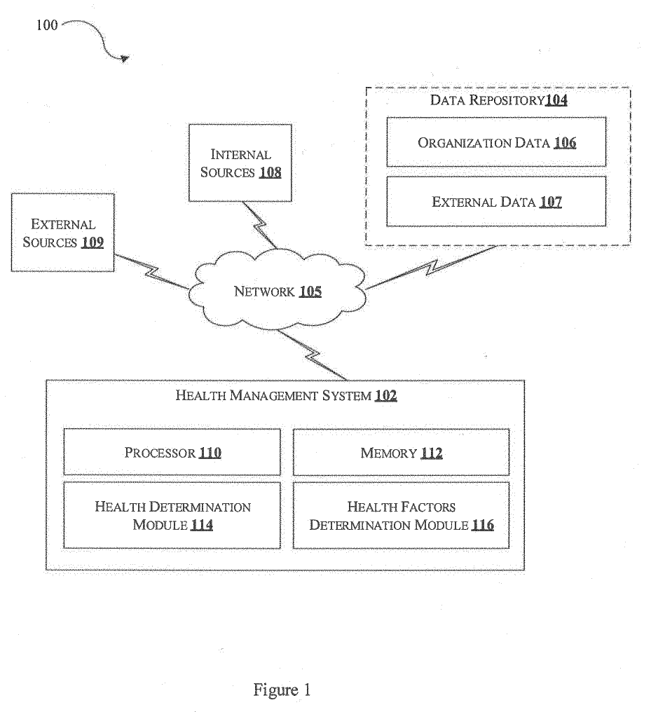

FIG. 1 illustrates an architecture diagram of an exemplary system for enabling health management in accordance with some embodiments of the present disclosure.

As shown in FIG. 1, the exemplary system 100 comprises one or more components configured for enabling health management of an organization. The system 100 may be implemented using a single computer or a network of computers including cloud-based computer implementations. In one embodiment, the exemplary system 100 comprises a health management system (hereinafter referred to as HMS) 102, and a data repository 104 connected via a communication network 105.

The data repository 104 may comprise a plurality of organization related data (hereinafter referred to as organization data) 106 and external data 107. In one example, the organization data 106 may be sales, net revenue, performance efficiency, operational efficiency, net growth, professional growth associated with the organization. The external data 107 may include for example, business reports, GDP information, social media impact factors, market analytics information, macroeconomic data and related data. The data repository 104 may be, in one embodiment, is configured as integrated repository within the HMS 102. In an embodiment, the master test repository 104 may be implemented as standalone storage system disposed external to the HMS 102.

The system 100 also comprises one or more internal sources 108 and one or more external sources 109 coupled with the HMS 102 via the network 106. The internal sources 108 may be for example, a plurality of internal business units associated with the organization. The external sources may be sources that provide external data like Business reports, funding information from leading organizations, GDP information of a country, social media impact factors, market analytics information, macroeconomic data and other related data. The data repository 104 retrieves the organization data 106 from the one or more internal sources 108 and the external data 107 from the one or more external sources 109 respectively for processing by the HMS 102.

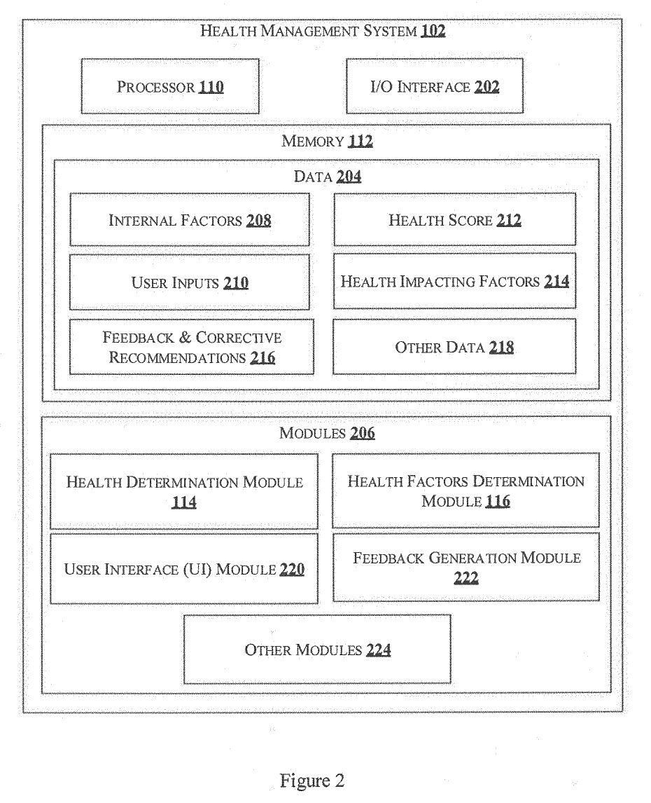

The HMS 102 comprises at least a processor 110 and a memory 112 coupled with the processor 110. The HMS 102 further includes a health determination module 114 and a health factors determination module (hereinafter referred to as HFDM) 116. The health determination module 114 is configured to determine the current health of the organization and the HFDM 116 determines the health affecting factors based on the organization data 106 and the external data 107 retrieved from the data repository 104. In one embodiment, the HMS 102 may be a typical HMS as illustrated in FIG. 2. The HMS 102 comprises the processor 110, the memory 112, and an I/O interface 202. The I/O interface 202 is coupled with the processor 110 and an I/O device. The I/O device is configured to receive inputs via the 1/O interface 202 and transmit outputs for displaying in the I/O device via the I/O interface 202. The I/O interface 202 may be configured to input user inputs required for customization and analysis of factors related to health of the organization.

The HMS 102 further includes data 204 and modules 206. In one implementation, the data 204 may be stored within the memory 112. In one example, the data 204 may include internal factors 208, user inputs 210, health score 212, health impacting factors 214, feedback and corrective recommendations 216 and other data 218. In one embodiment, the data 204 may be stored in the memory 112 in the form of various data structures. Additionally, the aforementioned data can be organized using data models, such as relational or hierarchical data models. The other data 216 may be also referred to as reference repository for storing recommended implementation approaches as reference data. The other data 216 may also store data, including temporary data, temporary files and predetermined threshold internal factors, correlation analysis, regression model, predetermined threshold health factors, generated by the modules 206 for performing the various functions of the HMS 102.

The modules 206 may include, for example, the health determination module 114, the HFDM module 116, a user interface (UI) module 220 and a feedback generation module 222. The modules 206 may also comprise other modules 224 to perform various miscellaneous functionalities of the HMS 102. It will be appreciated that such aforementioned modules may be represented as a single module or a combination of different modules. The modules 206 may be implemented in the form of software, hardware and/or firmware.

In operation, the HMS 102 may be configured to determine health of an organization to improve the performance of the organization. The health of the organization depends one or more health impacting factors that should be identified and improved to increase the performance of the organization. To improve the performance, the HMS 102 determines a plurality of health impacting factors 214 of the organization and provides feedback and corrective recommendations based on the determined plurality of health impacting factors 214. The HFDM 116 determines the plurality of health impacting factors 214 based on one or more internal factors 208 identified by the health determination module 114.

In one implementation, the health determination module 114 identifies the one or more internal factors 208 affecting the performance or health of the organization. The health determination module 114 determines the current health of an organization based on the organization data 106 retrieved from the data repository 104. The data repository 104 retrieves the organization data 106 from the one or more internal sources 108 and transmits to the health determination module 114. The health determination module 114 processes the received organization data 106 and determines a health score 212 indicating the current health state of the organization. In another implementation, the health score 212 can be determined by any health score determination method and techniques known. Based on the health score 212, the health determination module 114 identifies the one or more internal factors 208 associated with the health score 212. In one implementation, the health determination module 114 compares the one or more internal factors associated with the health score 212 with corresponding predetermined threshold internal factors. Based on the comparison, the health determination module 114 identifies the one or more internal factors 208 that are likely affecting the health score 212 of the organization. The internal factors 208 thus identified are responsible for determination of the plurality of health impacting factors 214 of the organization.

In one implementation, the HFDM 116 determines the plurality of health impacting factors 214 based on the one or more internal factors 208 identified by the health determination module 114 and based on the external data 107 received from the external sources 109. The HFDM 116 receives the external data 107 from the one or more external sources 109 and user inputs 210 from the user. The user inputs 210 comprise inputs related to customization and analysis requirements through selection of one or more parameters associated with the requirements. In one example, the one or more parameters that are provided as user inputs 210 may include analysis duration (quarterly, half-yearly, and yearly), type of industry, type of organizations to analyze, competition analysis, customer analysis and supplier analysis and other related user inputs. The user interface module 220 enables the user to provide the user inputs 210 for processing by the HFDM 116. Based on the external data 107 and the user inputs 210, the HFDM 116 determines a correlation analysis and generates a regression module based on the correlation analysis thus determined. In one implementation, the HFDM 116 determines a correlation analysis between the one or more internal factors 208 and the external data 107.

Based on the correlation analysis, the HFDM 116 generates the regression module to identify the plurality of health impacting factors 214. In one implementation, the HFDM 116 employs multi-variable regression analysis technique to build the regression module. The HFDM 116 generates a regression line or prediction line of internal factors 208 based on the external data 107. Based on the generated regression or prediction line, standard error is calculated and deviation in the standard error is determined. Based on the standard error deviation, the internal factors 208 and the external data 107 are modified to minimize the standard error deviation. The internal factors 208 corresponding to the minimum standard error associated with the regression analysis are determined as one or more health factors. The HFDM 116 compares the one or more health factors with corresponding predetermined threshold health factors to identify the plurality of health impacting factors 214 upon comparison. In one example, the predetermined threshold health factor may be the predetermined threshold standard error (SE).

The feedback generation module 222 generates a sample health report based on the determination of plurality of health impacting factors 214 and provides corrective recommendations or measures to improve the performance of the organization. In one example, the corrective recommendations 216 may include business related recommendations, analytics dashboard, predictive and prescriptive analysis. The feedback generation module 222 provides the performance feedback and the corrective recommendations 216 at one of the one of the organization level and an individual business unit level. Thus, the system 100 enables 360-degree view of the organization to determine the performance affecting factors with respect to competition, competitors and suppliers associated with an organization.

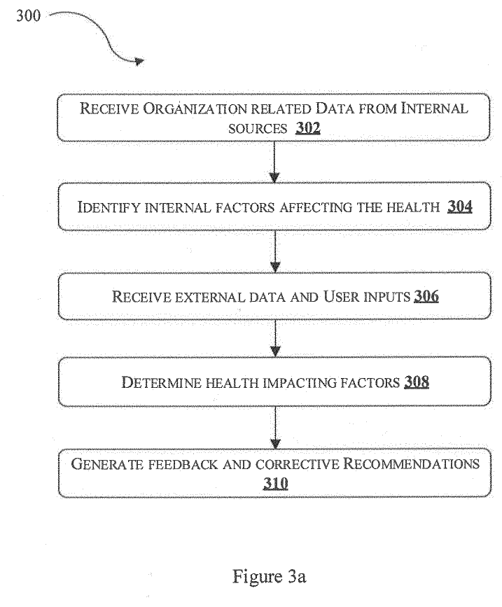

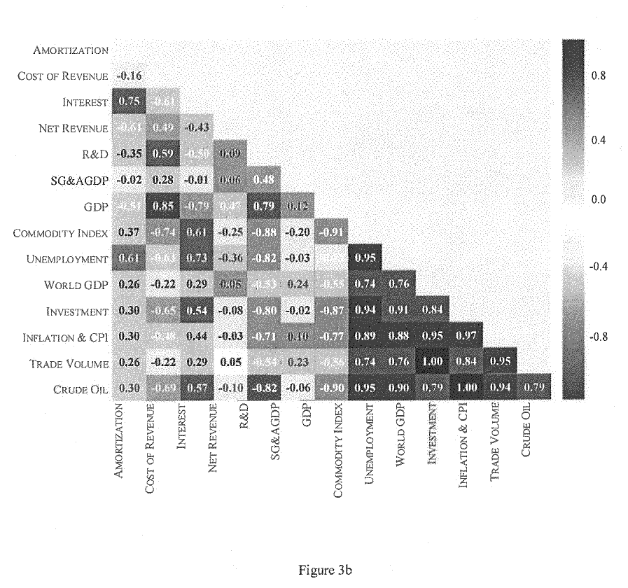

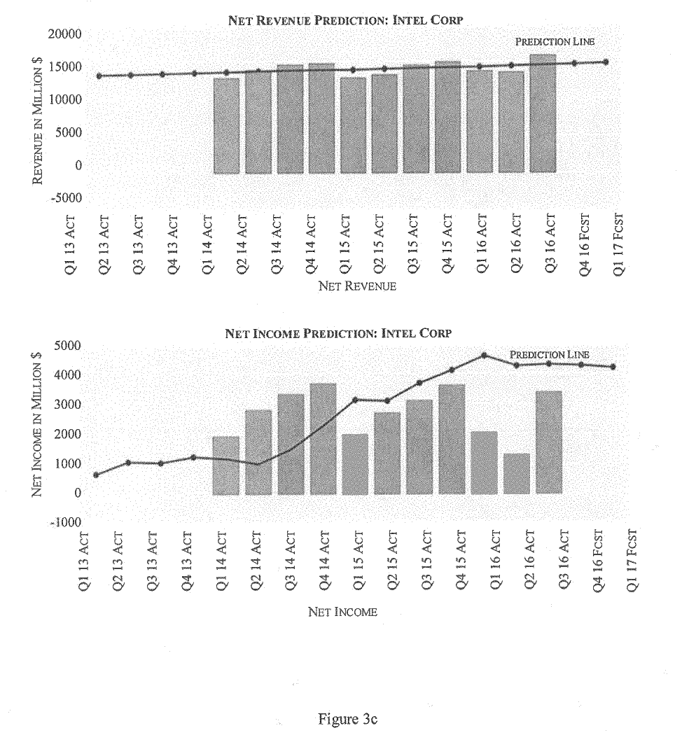

FIG. 3a illustrates a flowchart of an exemplary method of enabling health management of an organization in accordance with some embodiments of the present disclosure.

As illustrated in FIG. 3a, the method 300 comprises one or more blocks implemented by the processor 110 for facilitating health management of an organization. In one example, the HMS 102 may be configured to determine financial health of an organization to improve the performance of the organization. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the scope of the subject matter described herein. Furthermore, the method 300 can be implemented in any suitable hardware, software, firmware, or combination thereof.

At block 302, receive organization related data from internal sources. In one embodiment, the health determination module 114 determines the current health of an organization based on the organization data 106 retrieved from the data repository 104. The data repository 104 retrieves the organization data 106 from the one or more internal sources 108 and transmits to the health determination module 114.

At block 304, identify internal factors affecting the health of an organization. In one embodiment, the health determination module 114 identifies the one or more internal factors 208 affecting the performance or health of the organization. The internal factors 208 affecting the financial health may be for example, sales, expenses, net revenue, revenue growth, earning growth, gross margin, operating cash flow growth, solvency ratio, and other related factors. The health determination module 114 processes the received organization data 106 and determines a health score 212 indicating the current health state of the organization. Based on the health score 212, the health determination module 114 identifies the one or more internal factors 208 associated with the health score 212. In one implementation, the health determination module 114 compares the one or more internal factors associated with the health score 212 with corresponding predetermined threshold internal factors. Based on the comparison, the health determination module 114 identifies the one or more internal factors 208 that are likely affecting the health score 212 of the organization. The internal factors 208 thus identified are responsible for determination of the plurality of health impacting factors 214 of the organization.

At block 306, receive external data and user inputs. In one embodiment, the HFDM 116 receives the external data 107 from the one or more external sources 109 and user inputs 210 from the user. The external data 107 may be for example, world GDP growth, inflation rate, commodity index, price information of crude oil, china population, and other macro-economic data. The user inputs 210 comprise inputs related to customization and analysis requirements through selection of one or more parameters associated with the requirements. In one example, the one or more parameters that are provided as user inputs 210 may include analysis duration (quarterly, half-yearly, and yearly), type of industry, type of organizations to analyze, competition analysis, customer analysis and supplier analysis and other related user inputs. The user interface module 220 enables the user to provide the user inputs 210 for processing by the HFDM 116.

At block 308, determine health impacting factors. In one embodiment, the HFDM 116 determines a correlation analysis between the one or more internal factors 208 and the external data 107. An example illustration of the correlation analysis is depicted in FIG. 3b, where the world GDP growth is correlated with Net Revenue of Intel Corporation.

Based on the correlation analysis, the HFDM 116 generates the regression module to identify the plurality of health impacting factors 214. In one implementation, the HFDM 116 employs multi-variable regression analysis technique to build the regression module. The HFDM 116 generates a regression line or prediction line of internal factors 208 based on the external data 107. FIG. 3c illustrated the prediction line of Intel Corporation for net revenue prediction and net income prediction. Based on the generated regression or prediction line, standard error is calculated and deviation in the standard error is determined. Based on the standard error deviation, the internal factors 208 and the external data 107 are modified to minimize the standard error deviation. The internal factors 208 corresponding to the minimum standard error associated with the regression analysis are determined as one or more health factors. The HFDM 116 compares the one or more health factors with corresponding predetermined threshold health factors to identify the plurality of health impacting factors 214 upon comparison.

At block 310, generate feedback and corrective recommendations. In one embodiment, the feedback generation module 222 generates a sample health report based on the determination of plurality of health impacting factors 214 and provides corrective recommendations or measures to improve the performance of the organization. In one example, the corrective recommendations 216 may include business related recommendations, analytics dashboard, predictive and prescriptive analysis. The feedback generation module 222 provides the performance feedback and the corrective recommendations 216 at one of the one of the organization level and an individual business unit level.

Thus, the system 100 enables 360-degree view of the organization to determine the performance affecting factors with respect to competition, competitors and suppliers associated with an organization.

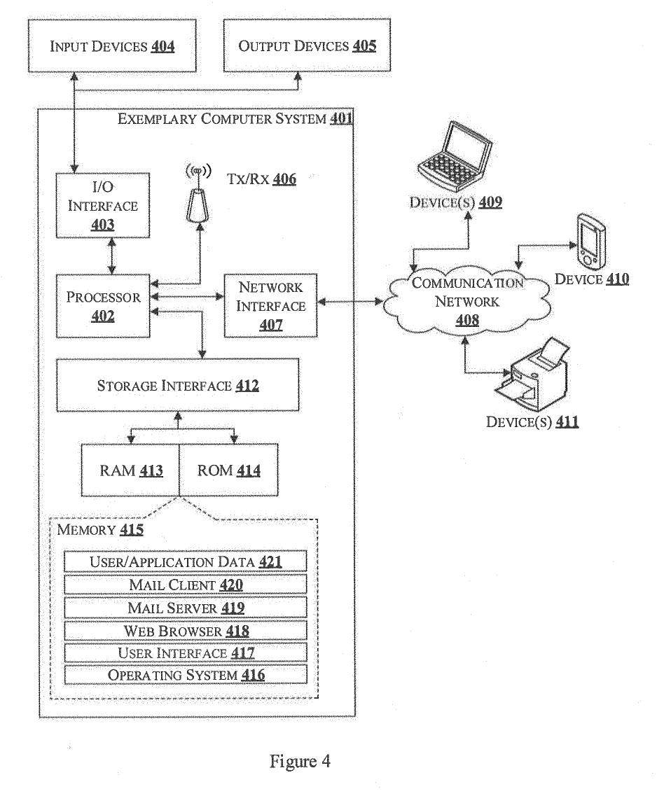

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. The processor 402 may comprise at least one data processor for executing program components for executing user- or system-generated requests. The processor 402 may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver 406 may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HI-SDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices 409, 410 and 411 may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface 412 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, a user interface application 5Error! Reference source not found.17, a web browser 418, a mail server 419, a mail client 420, user/application data 421 (e.g., any data variables or data records discussed in this disclosure), etc. The operating system 416 may facilitate resource management and operation of the computer system 401. Examples of the operating system 416 include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. The user interface application 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program components. The web browser 418 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. The web browser 418 may utilize facilities such as AJAX, DHTML, Adobe Flash, JavaScript, Java, application programming interfaces (APIs), etc. In some embodiments, the computer system 401 may implement a mail server 419 stored program components. The mail server 419 may be an Internet mail server such as Microsoft Exchange, or the like. The mail server 419 may utilize facilities such as ASP, ActiveX, ANSI C++/C#, Microsoft .NET, CGI scripts, Java, JavaScript, PERL, PHP, Python, WebObjects, etc. The mail server 419 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program components. The mail client 420 may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

Advantages of the Embodiment of the Present Disclosure are Illustrated Herein

In an embodiment, the present disclosure enables 360-degree view of the organization to determine the performance affecting factors with respect to competition, competitors and suppliers associated with an organization.

In an embodiment, the present disclosure automatically provides feedback and corrective recommendations to improve the performance of the organization.

It is intended that the disclosure and examples be considered as exemplary only, with a true scope and spirit of disclosed embodiments being indicated by the following claims.

What is claimed is:

1. A method of identifying health impacting factor to improve performance of an organization, method comprising:
receiving, by a processor (110) of a health management system (102), a plurality of organization related data (106) collected from one or more internal sources (108) associated with the organization;
identifying, by the processor (110), one or more internal factors (208) affecting the health of the organization based on processing of the plurality of organization related data (106);
receiving, by the processor (110), external data (107) from a plurality of external sources (109) and one or more user inputs (210) related to customization requirements;
determining, by the processor (110), a plurality of health impacting factors (214) of the organization based on the analysis of the one or more internal factors (208) and the external data (107) received; and
generating, by the processor (110), feedback and corrective recommendations (216) to improve the performance of the organization based on the plurality of health impacting factors (214).

2. The method as claimed in claim 1, wherein identifying the one or more internal factors (208) comprising:
processing the plurality of organization related data (106) received from the one or more internal sources (108);
determining a health score (212) indicating the current health state of the organization; and
identifying the one or more internal factors (208) associated with the current health score (212) based on comparison of the predetermined threshold internal factors.

3. The method as claimed in claim 1, wherein determining the plurality of health impacting factors (214) comprising:
determining a correlation analysis between the received internal factors (208) and external data (107);
generating a regression model for the internal factors (208) and external data (107) based on the correlation analysis;
determining one or more health factors based on the generated regression model; and
identifying the plurality of health impacting factors (214) based on comparison of the one or more health factors with corresponding predetermined threshold health factors.

4. The method as claimed in claim 1, wherein the feedback comprising performance feedback at one of an organization level and an individual business unit level.

5. The method as claimed in claim 1, wherein the corrective recommendations are provided at the one of the organization level and an individual business unit level for improving the overall health of the organization.

6. The method as claimed in claim 1, wherein the external data comprises business reports, GDP information, social media impact factors, market analytics information, macroeconomic data and related data.

7. A health management system for an organization, system comprising:
a data repository (104), configured to store a plurality of organization related data, and external data (107) received from a plurality of external sources (109);
a processor (110) coupled to interact with the data repository (104); and
a memory (112), communicatively coupled to the processor (110), wherein the memory (112) stores processor-executable instructions, which, on execution, cause the processor (110) to:
receive the plurality of organization related data (106) collected from one or more internal sources (108) associated with the organization;
identify one or more internal factors (208) affecting the health of the organization based on processing of the plurality of organization related data (106);
receive the external data (107) and one or more user inputs (210) related to customization requirements;
determine a plurality of health impacting factors (214) of the organization based on the analysis of the one or more internal factors (208) and the external data (107) received; and
generate feedback and corrective recommendations (216) to improve the performance of the organization based on the plurality of health impacting factors (214).

8. The system as claimed in claim 7, wherein the processor (110) is configured to identify the one or more internal factors (208) by:
processing the plurality of organization related data (106) received from the one or more internal sources (108);
determining a current health score (212) indicating the current health state of the organization; and
identifying the one or more internal factors (208) associated with the current health score (212) based on comparison of the predetermined threshold internal factors.

9. The system as claimed in claim 7, wherein the processor (110) is configured to determine the plurality of health impacting factors (214) by:
determining a correlation analysis between the received internal factors (208) and external data (107);
generating a regression model for the internal factors (208) and external data (107) based on the correlation analysis;
determining one or more health factors based on the generated regression model; and
identifying the plurality of health impacting factors (214) based on comparison of the one or more health factors with corresponding predetermined threshold health factors.

10. The system as claimed in claim 7, wherein the processor (110) is configured to generate the feedback comprising performance feedback at one of an organization level and an individual business unit level.

11. The system as claimed in claim 7, wherein the processor (110) is configured to generate corrective recommendations provided at the one of the organization level and an individual business unit level for improving the overall performance of the organization.

12. The system as claimed in claim 7, wherein the processor (110) is configured to receive the external data that comprises business reports, GDP information, social media impact factors, market analytics information, macroeconomic data and related data.

13. A non-transitory computer readable medium including instructions stored thereon that when processed by at least one processor (110) cause a test automation system (102) to perform acts of:
receiving a plurality of organization related data (106) collected from one or more internal sources (108) associated with the organization;
identifying one or more internal factors (208) affecting the health of the organization based on processing of the plurality of organization related data (106);
receiving external data (107) from a plurality of external sources (109) and one or more user inputs (210) related to customization requirements;
determining a plurality of health impacting factors (214) of the organization based on the analysis of the one or more internal factors (208) and the external data (107) received; and
generating feedback and corrective recommendations (216) to improve the performance of the organization based on the plurality of health impacting factors (214).

14. The medium as claimed in claim 13, wherein the instructions stored thereon further causes the at least one processor (110) to identify the one or more internal factors (208) by:
processing the plurality of organization related data (106) received from the one or more internal sources (108);
determining a health score (212) indicating the current health state of the organization; and
identifying the one or more internal factors (208) associated with the current health score (212) based on comparison of the predetermined threshold internal factors.

15. The medium as claimed in claim 13, wherein the instructions stored thereon further causes the at least one processor (110) to determine the plurality of health impacting factors (214) by:
determining a correlation analysis between the received internal factors (208) and external data (107);
generating a regression model for the internal factors (208) and external data (107) based on the correlation analysis;
determining one or more health factors based on the generated regression model; and
identifying the plurality of health impacting factors (214) based on comparison of the one or more health factors with corresponding predetermined threshold health factors.

16. The medium as claimed in claim 13, wherein the feedback comprising performance feedback at one of an organization level and an individual business unit level.

17. The medium as claimed in claim 13, wherein the corrective recommendations (216) are provided at the one of the organization level and an individual business unit level for improving the overall health of the organization.

18. The medium as claimed in claim 13, wherein the external data (107) comprises business reports, GDP information, social media impact factors, market analytics information, macroeconomic data and related data.
